(19) United States
(12) Patent Application Publication
(10) Pub. No.: US 2008/0308594 A1
(43) Pub. Date: Dec. 18, 2008

(54) Nail gun shield

(76) Inventor: Bruno Schettini, Allentown, PA (US)

Correspondence Address: DAVID E ORR, 4616 NE 134TH STREET, VANCOUVER, WA, 98686, US

(21) Appl. No.: 11/901,792

(22) Filed: Sep. 20, 2007

Related U.S. Application Data
(60) Provisional application No. 60/934,643, filed on Jun. 15, 2007.

(51) Int. Cl. B25F 5/00

(52) U.S. Cl. 227/110

(57) ABSTRACT

A protective shield for a nail gun, to prevent injury to the nail gun user. The shield comprises a shield adapted to be bolted or removably affixed to a nail gun. The shield further includes a transparent flexible skirt at the bottom of the shield. The shield encloses a portion of the nail gun and prevents ricocheting nails from contacting and injuring or killing the user of the nail gun. The flexible skirt provides further protection and is made to dynamically adapt to fully enclose the work area surrounding the nail gun barrel, and yet permit the user full view of the work area.

### RELATED APPLICATIONS

This application is related to and derives priority from U.S. Provisional application No. 60/934,643 filed on Jun. 15, 2007, which is included herein by reference.

### FIELD

The present invention relates to hand tools; more specifically the present invention is a shield for attachment to a nail gun to improve safety in use.

### BACKGROUND

A nail gun or nailer is a type of tool used to drive nails into wood or some other kind of material. It is usually driven by electromagnetism, compressed air, or, for powder-actuated tools, a small explosive charge. Smaller nail guns are often called brad nailers, bradders, or pin nailers. Nail guns have in many ways replaced hammers as tools of choice amongst builders.

Nail guns also have many advantages over hammers, as they drive the fastener instantly, without splitting the wood, and consistently set the nail head below the surface.

Most nail guns can be set to operate in either of two modes. In one mode, the nail gun must first be pressed against the work piece and the trigger then depressed. One nail is then fired and the trigger must be released before the next nailing cycle can commence. In the other mode, the trigger is depressed before the nail gun is brought into contact with the work piece. Then, each time the nail gun is pressed against the work piece, a nailing cycle commences and one nail is fired. By repeatedly “bumping” the nail gun against the work piece, any number of nails can be rapidly fired. This mode is very fast, although less precise than the first mode.

Nail guns do not use conventional nails. Instead, the nails are provided mounted in long strips (similar to a stick of staples) or in a plastic carrier coil. Each style of nail gun will be either stick- or coil-loading, although it may operate with nails of a variety of lengths. The gauge (thickness) of the nail is usually fixed for any given model of nail gun. The most common firing mechanism is the dual-action contact-trip trigger, which requires that the manual trigger and nose contact element both be depressed for a nail to be discharged. The sequential-trip trigger, which is safer, requires the nose contact to be depressed before the manual trigger, rather than simultaneously with the trigger. Approximately 65% to 69% of injuries from contact-trip tools likely could be prevented through use of a sequential-trip trigger instead, according to the U.S. Centers for Disease Control CDC.

In the U.S., about 37,000 people every year go to emergency rooms with injuries from nail guns, according to the CDC. Forty percent of those injuries occur to consumers. Nail gun injuries have tripled from 1991 to 2005.

All kinds of nail guns can be dangerous, so safety precautions similar to those for a firearm are usually recommended for their use. For safety, nail guns are designed to be used with the muzzle touching the target; they are short-range and inaccurate if a user tries to use one as a projectile weapon.

### OBJECTS AND BENEFITS

In view of, and in response to, the extreme danger presented by nail guns, a new invention is disclosed. This new invention, a nail gun shield is designed with several objectives and benefits in mind. A first object is a shield for a nail gun that dramatically reduces the chance of injury or death.

A second object is a nail gun shield that is inexpensive to purchase.

Another object is a nail gun shield that is easy to install and easy to remove.

And yet another object is a nail gun shield that aids a user in using a nail gun.

Other benefits and advantages of the invention will appear from the disclosure to follow. In the disclosure reference is made to the accompanying drawings, which form a part hereof and in which is shown by way of illustration a specific embodiment in which the invention may be practiced. This embodiment will be described in sufficient detail to enable those skilled in the art to practice the invention, and it is to be understood that other embodiments may be utilized and that structural changes may be made in details of the embodiments without departing from the scope of the invention.

### SUMMARY

A shield for a nail gun, the shield comprising a shield adapted to be bolted or removably affixed to a nail gun. The shield further includes a transparent flexible skirt at the bottom of the shield. The transparent skirt affords the user a view of the work area in order to properly position the nail gun.

The shield prevents ricocheting nails from contacting and injuring the user of the nail gun. The flexible skirt provides further protection and is made to dynamically adapt to fully enclose the work area surrounding the nail gun barrel, and yet permit the user full view of the work area. A nail will ricochet when it strikes a stud, another nail, a solid metallic surface, or a knot in the wood. The obvious danger to the user is that the nail may ricochet into the nail gun user's face, head, neck, or thorax and be a lethal strike. More commonly the nail will strike the user's hand. If a nerve is struck even this common injury may lead to long-term disability.

### DESCRIPTION OF DRAWINGS

FIG. 1 is a view of an exemplary embodiment of the nail gun.

FIG. 2 shows the structure of the shield with skirt.

### DETAILED DESCRIPTION

### An Exemplary Embodiment

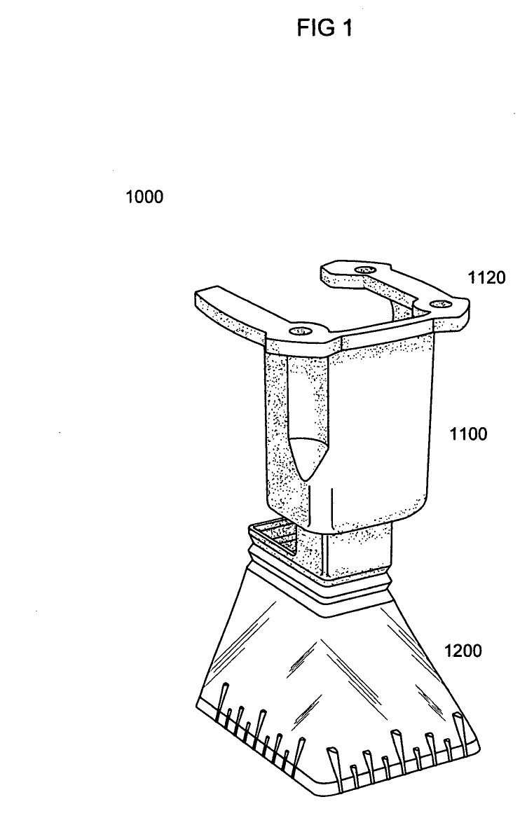

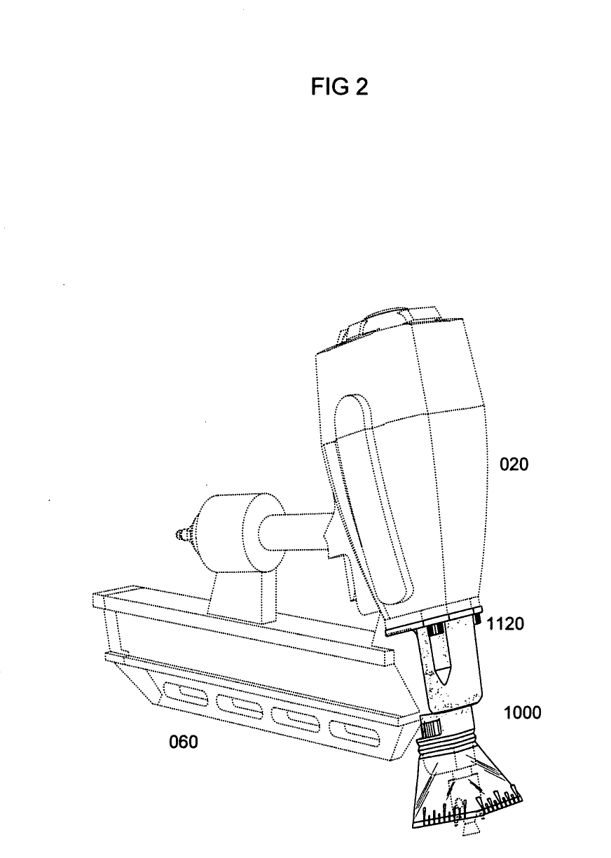

With reference to FIG. 1 and FIG. 2, a shield for a nail gun is shown in an exemplary embodiment. From this disclosure, those skilled in the art of designing, making and using hand tools may derive alternative embodiments that are equivalent in view of the claims accompanying this disclosure.

With reference to FIG. 1, the nail gun shield 1000 comprises a shield 1100 for attachment to a nail gun (such as shown in FIG. 2, labeled as 020) and to enclose the nail gun barrel (FIG. 2, labeled as 040) and to protect the user of the nail gun from injury by nails exiting the nail gun chute* (FIG. 2 060) by ricocheting from the work surface.

With reference to FIG. 1, the nail gun guard is configured with an adapter or attachment means 1120 to permit attachment of the shield 1000 to standard nail guns. It will be appreciated that the manner and means of attachment (as illustrated by 1120 in FIG. 1) may vary from nail gun to nail gun.

With reference to FIG. 1, the shield 1000 further includes a shield body 1100 with a flexible skirt 1200 that is attached to the bottom of the shield (shown attaching to the shield body labeled 1100), and which surrounds and encloses the area into which nails are driven. The skirt 1200 is made to dynamically adapt to changing surfaces so as to fully enclose the work area surrounding the nail gun barrel. The skirt 1200 is made from transparent material to afford the user full view of the work area.

An important aspect of the design is that the shield's width, with respect to the nozzle of the nail gun, should be at a minimum as wide as the nail is long. When the nail ricochets from the surface it strikes it will either embed into the plastic shield or bounce off the shield back onto the work surface and eventually lose momentum so there will be no injury.

In operation the shield will remain pressed onto the work surface until the ricocheted nail has stopped moving.

With reference to FIG. 2, the shield 1000 is shown attached to a nail gun 020 having a nail chute 040.

With reference to FIG. 1 and FIG. 2, the nail gun shield is made of lightweight metal or plastic or composite material capable of withstanding a sharp nail acting as a projectile.

A single exemplary embodiment of the invention have been disclosed. It will be appreciated that the embodiment and its variant are directed to a nail gun shield that will protect a nail gun user from ricocheting nails.

The full scope and description of the invention is given by the claims that follow.

What is claimed is:

1. A shield for a nail gun, the shield for protecting a user of the nail gun from injury by an ejected nail to be nailed into a work area, the shield comprising a shield body having an attachment means for attaching the shield to a nail gun, the shield further having a transparent, flexible skirt attached to the bottom of the shield, whereby the work area is enclosed and visible to the user.

2. The shield of claim 1 wherein the width of the skirt, with respect to the nail gun nozzle, is at least as long as the nail used in the nail gun.
